(19) United States
(12) Patent Application Publication
(10) Pub. No.: US 2011/0153119 A1
(43) Pub. Date: Jun. 23, 2011

(54) METHOD AND DEVICE FOR CONTROLLING VEHICLE APPROACHING INTERSECTION

(75) Inventors: Ho-Geun LEE, Daejeon (KR); Seok-Jin LEE, Daegu (KR); Jang-Sik BAE, Daejeon (KR)

(73) Assignee: Electronics and Telecommunications Research Institute, Daejeon-city (KR)

(21) Appl. No.: 12/967,777

(22) Filed: Dec. 14, 2010

(30) Foreign Application Priority Data
Dec. 18, 2009 (KR) 10-2009-0126700
Apr. 12, 2010 (KR) 10-2010-0033396

(51) Int. Cl. G06F 7/00

(52) U.S. Cl. 701/2

(57) ABSTRACT

Provided are a method and a device for controlling a vehicle approaching an intersection, and more particularly, a method and a device for controlling a vehicle approaching an intersection, which controls a vehicle approaching an intersection by selecting a traffic signal for the vehicle. The method of controlling a vehicle approaching an intersection includes: collecting traffic light information including signal cycles and positional coordinates of traffic lights installed at the intersection; selecting a corresponding traffic light among the traffic lights in consideration of positional information of the vehicle at the intersection and the positional coordinates of the traffic lights; and controlling the vehicle on the basis of the signal cycle of the corresponding traffic light.

### CROSS REFERENCE TO RELATED APPLICATIONS

This application claims the benefit of Korean Patent Application No. 10-2009-0126700 filed on Dec. 18, 2009 and Korean Patent Application No. 10-2010-0033396 filed on Apr. 12, 2010, which are hereby incorporated by reference in their entirety into this application.

### BACKGROUND OF THE INVENTION

1. Field of the Invention

The present invention relates to a method and a device for controlling a vehicle approaching an intersection, and more particularly to a method and a device for controlling a vehicle approaching an intersection, which controls a vehicle approaching an intersection by selecting a signal for the vehicle.

2. Description of the Related Art

In general, idling of vehicles is a cause of air pollution, in addition to unnecessarily consuming energy.

Accordingly, a method has been proposed, which simply receives and uses traffic light information from a transmitter installed in a traffic light in order to prevent idling of vehicles in the related art.

The method, however, is difficult to practically use, because traffic lights are installed for various types of intersections, such as three-way traffic lights, five-way traffic lights, and two-way traffic lights for a simple crossing, in addition to four-way traffic lights.

Therefore, the method that has been proposed in the art to prevent idling of vehicles cannot be applied to the traffic lights installed at intersections, except for a one-way traffic light, because it uses only a specific color signal. That is, there is no basis for determining which direction the transmitted radio signal indicates, which direction the vehicle travels in, or which intersection the vehicle approaches, for the other types of intersections. Therefore, the method has a problem in that it cannot be practically applied to the traffic lights installed at all of the existing intersections.

### SUMMARY OF THE INVENTION

The present invention has been made in an effort to provide a method and device that can control the start of the engine on the basis of the signal cycle of a traffic light in the vehicle travel direction, when a vehicle equipped with an anti-idling device or having other objects reaches an intersection and stops for a signal.

Further, the present invention has been made in an effort to provide a method and a device that can discriminate the condition of a traffic light in the vehicle travel direction regardless of whether the vehicle will travel straight or turn left, or where the vehicle is positioned at the intersection, at various types of intersections.

An exemplary embodiment of the present invention provides a method of controlling a vehicle approaching an intersection includes: collecting traffic light information including signal cycles and positional coordinates of traffic lights installed at the intersection; selecting a corresponding traffic light among the traffic lights in consideration of positional information of the vehicle at the intersection and the positional coordinates of the traffic lights; and controlling the vehicle on the basis of the signal cycle of the corresponding traffic light.

The selecting of a traffic light may determines a travel direction on the basis of the positional information of the vehicle at the intersection; and selects a corresponding traffic light among the traffic lights by matching the positional coordinates of the traffic lights with the travel direction of the vehicle in a coordinate plane.

In the selecting, selecting a corresponding traffic light among the traffic lights may be to select a traffic light on the road where the vehicle will travel.

In the selecting, selecting a corresponding traffic light among the traffic lights may be to select the farthest traffic light among the traffic lights on the road where the vehicle will travel.

Another exemplary embodiment of the present invention provides a device for controlling a vehicle approaching an intersection includes: a traffic light information process unit that collects traffic light information including signal cycles and positional coordinates of traffic lights installed at the intersection; a traffic light selecting unit that selects a corresponding traffic light among the traffic lights in consideration of positional information of the vehicle at the intersection and the positional coordinates of the traffic lights; and a vehicle control unit that controls the vehicle on the basis of the signal cycle of the corresponding traffic light.

According to the exemplary embodiments of the present invention, it is possible to efficiently control prevention of idling of a vehicle equipped with an anti-idling device or having other objects, by controlling the start of the engine of the vehicle on the basis of the signal cycle of a traffic light in the travel direction of the vehicle at the intersection.

Further, the present invention has the advantage of accurately discriminating a message of the traffic light to refer to, using the positional information of the traffic light and the travel information coordinates of the vehicle at the intersection.

Further, the present invention can be used for controlling a vehicle by selecting a traffic light that the vehicle will refer to, at various types of intersections

### BRIEF DESCRIPTION OF THE DRAWINGS

FIG. 1 is a view showing traffic lights at an intersection according to an exemplary embodiment of the present invention;

FIG. 2 is a view showing FIG. 1 with a coordinate system;

FIG. 3 is a view showing a four-way intersection according to an exemplary embodiment of the present invention;

FIG. 4 is a view showing a four-way intersection according to another exemplary embodiment of the present invention;

FIG. 5 is a view showing a three-way intersection according to an exemplary embodiment of the present invention;

FIG. 6 is a diagram illustrating the configuration of a transmitter according to an exemplary embodiment of the present invention;

FIG. 7 is a diagram illustrating the configuration of a receiver according to an exemplary embodiment of the present invention;

FIG. 8 is a diagram illustrating the internal configuration of the control unit shown in FIG. 4; and

FIG. 9 is a flowchart illustrating a method of controlling a vehicle approaching an intersection according to an exemplary embodiment of the present invention.

### DETAILED DESCRIPTION OF THE PREFERRED EMBODIMENTS

Hereinafter, exemplary embodiments of the present invention will be described in detail with reference to the accompanying drawings. The following description and the accompanying drawings are provided to help understand the present invention and the well-known configuration and operation that unnecessarily make the subject of the present invention unclear are not described.

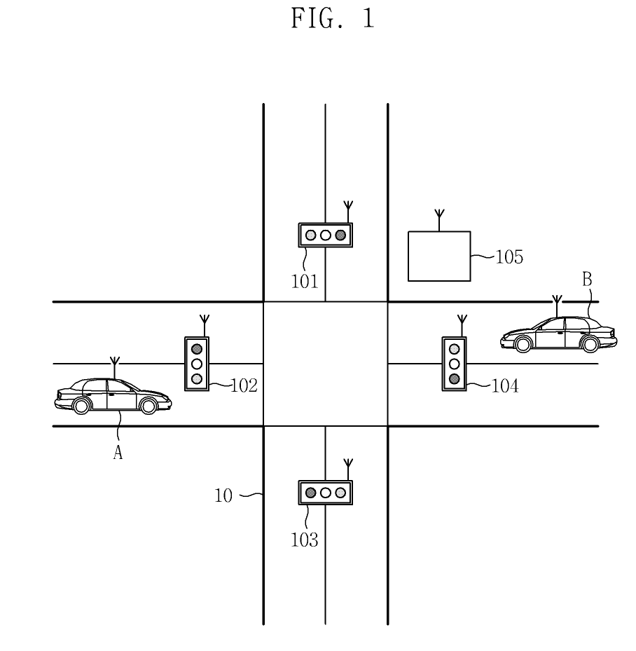

FIG. 1 is a view showing traffic lights at an intersection according to an exemplary embodiment of the present invention.

Referring to FIG. 1, a system using a method of controlling a vehicle approaching an intersection according to an exemplary embodiment of the present invention includes a transmitter and a receiver.

The transmitter wirelessly transmits traffic light information including positional coordinates and signal cycles of traffic lights 101 to 104 at an intersection. The transmitter is disposed in each of the traffic lights 101 to 104 installed the intersection or may be disposed in a traffic light controller 105 that controls the traffic lights 101 to 104.

The receiver wirelessly receives the information on the traffic lights at the intersection from the transmitter and controls the vehicles. Although the receiver may be disposed in the vehicles having an anti-idling function, it is not limited thereto.

The receiver starts or stops the engine to prevent idling of the vehicle on the basis of signal cycles of the traffic lights. That is, the receiver receives traffic light information on a specific traffic light and determines whether to stop or restart the engine of a vehicle in order to prevent idling in accordance with the remaining signal cycle of the traffic light.

The signal cycle may be changing timing information of the traffic light.

Further, the receiver selects a traffic light to refer to in accordance with the position of a vehicle on the basis of the traffic light system. That is, the receiver collects traffic light information transmitted from the transmitter, when a vehicle reaches the intersection 10 and stops in accordance with a signal of a traffic light. The receiver selects a corresponding traffic light among the traffic lights in consideration of the positional coordinates of the traffic lights included in the received traffic light information and the positional information on the vehicle at the intersection. Accordingly, the receiver controls the vehicle on the basis of the signal cycle of the corresponding traffic light.

For example, a receiver installed in a vehicle A refers to the traffic light 104 installed across the intersection 10 in the traffic lights 101 to 104 at the intersection shown in FIG. 1 in order to ensure the view of the driver in the vehicle A. The traffic light 104 that the receiver refers to should be positioned on the road in the travel direction of the vehicle at the intersection. That is, the receiver refers to the traffic light 104 corresponding to the travel direction of the vehicle in the traffic lights 101 to 104 at the intersection 10.

The traffic light system for the intersection is simply described. The driver of the vehicle A determines whether to go straight, turn left/right, or stop in accordance with the traffic light 104 positioned across the intersection. Further, the driver of the vehicle B also determines whether to go from the lights of the traffic light 102 positioned across the intersection. That is, for a one-way traffic light, a vehicle at the intersection 10 should select and refer to the farthest traffic light in the vehicle travel direction in the traffic lights at the intersection 10, that is, in the straight direction, in accordance with the position of the vehicle at the intersection 10.

However, not all intersections are made to go east, west, south, and north, that is, accurately arranged in four directions, but most intersections are usually made in various shapes in accordance with the geographical features of the places. Further, it is difficult to determine to select and refer to which direction traffic light in a plurality of traffic lights, for intersections of two or more roads, including two-way, three-way, four-way, and five-way intersections. For example, for the vehicle A shown in FIG. 1, it is difficult to determine to refer to the traffic light information of which traffic light, when the transmitters in the traffic lights installed at the intersection each transmit traffic light information.

Therefore, it is possible to discriminate a traffic light corresponding to the vehicle regardless of the shape of intersections, by applying a coordinate system to the traffic lights at the intersections in the present invention.

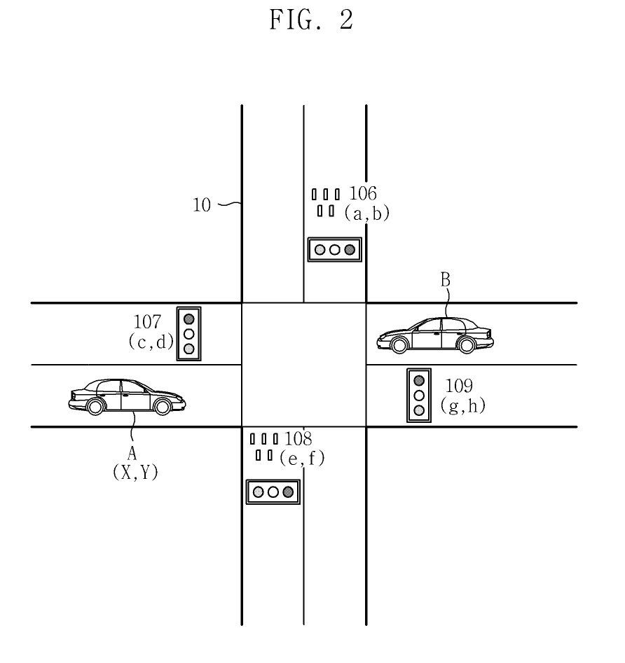

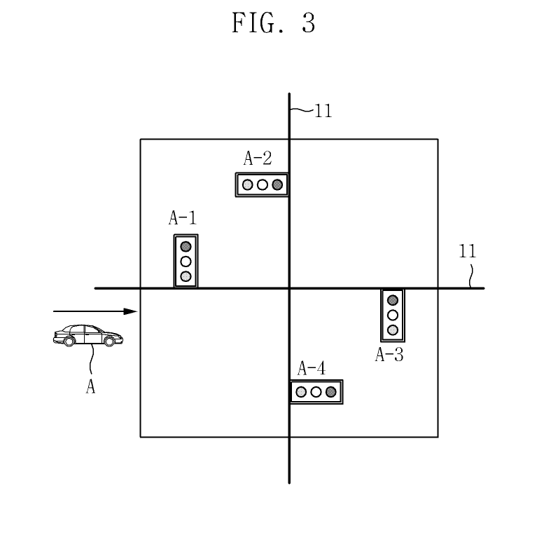

FIG. 2 is a view of FIG. 1 where GPS coordinates are applied and FIG. 3 is a view showing a four-way intersection according to an exemplary embodiment of the present invention.

Referring to FIG. 2, the receiver determines the travel direction on the basis of the positional information (x, y) of a vehicle at the intersection. Further, the receiver can select a corresponding traffic light among the traffic lights by matching the positional information (a, b), (c, d), (e, f), (g, h) of the traffic lights 106, 107, 108, and 109 with the travel direction of the vehicle in the coordinate plane. The positional information of the vehicles may include the coordinate number of accurate GPS longitude and latitude.

For example, for the vehicle A, assume that the positional information of the four traffic lights and the positional information (X, Y) of the vehicle A at the intersection shown in FIG. 2 are known. In this case, the positions (a, b), (c, d), (e, f), and (g, h) of the traffic lights 106, 107, 108, and 109 are generally represented by points on a rectangle, which is not a perfect rectangle for the features of the intersection, if the GPS coordinates of the traffic lights are shown in the coordinate plane in the figure.

Therefore, as shown in FIG. 3, it is preferable for the receiver to select a traffic light positioned in the travel direction of the vehicle on the roads 11, when selecting a traffic light corresponding to the vehicle at the intersection 10. In this embodiment, it is possible to represent the coordinates A-1, A-2, A-3, and A-4 of four traffic lights and the coordinates of one vehicle. This exemplifies the coordinates of an intersection and a vehicle which can be easily seen, because the shape of most intersections is not a perfect rectangle. That is, the receiver can select the traffic light A-3 positioned on the road where the vehicle A travels, as a traffic light to refer to.

Further, the receiver can select the farthest traffic light among the traffic lights on the road in the traveling direction of a vehicle, when selecting a traffic light corresponding to the vehicle approaching the intersection.

For example, assuming that a traffic light that the vehicle A will refer to is the traffic light A-3, a condition for selecting A-3 in the coordinate system, which is usually stopped, is to select the farthest traffic light from the vehicle A. However, the traffic light having the largest absolute distance from the vehicle A may not be the traffic light A-3, in accordance with the shape of intersections. Therefore, it is preferable in the present invention to select an algorithm selecting the traffic light A-3 that is the farthest in the vehicle travel direction, for example, in the direction that the vehicle travel direction vector 11 indicates.

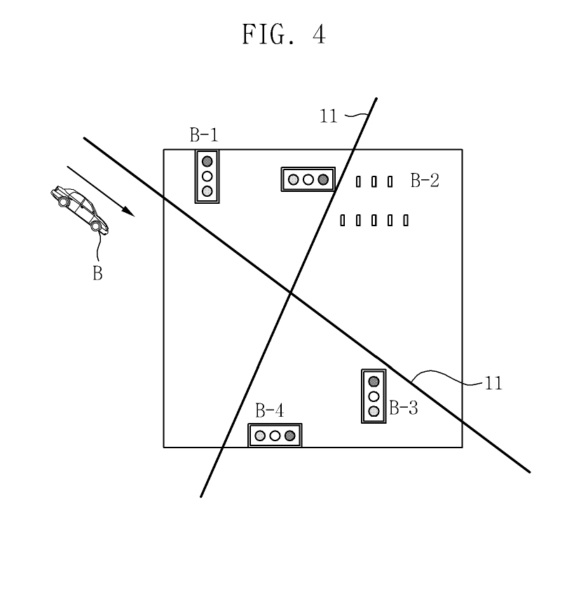

FIG. 4 is a view showing a four-way intersection according to another exemplary embodiment of the present invention.

FIG. 4 shows an irregular intersection, in which it is assumed that the absolute distance between the vehicle B and the traffic light B-3 is close to the absolute distance between the vehicle B and the traffic light B-4. In this case, the travel direction of the vehicle is in a four o'clock direction indicated by the vector 11, in which it is easy to discriminate a corresponding traffic light, because the traffic light B-3 is more clearly seen than the traffic light B-4 in the four o'clock direction.

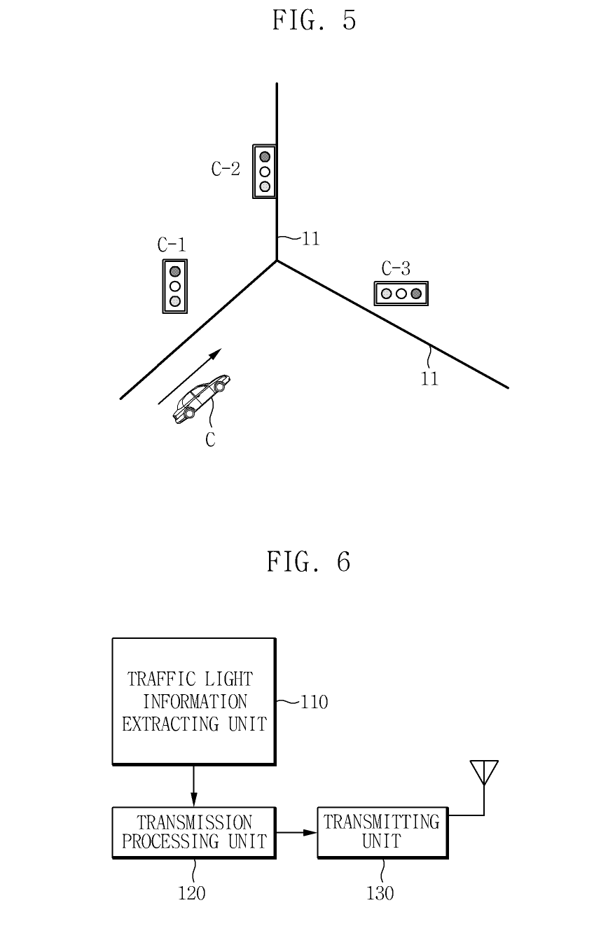

FIG. 5 is a view showing a three-way intersection according to an exemplary embodiment of the present invention.

Referring to FIG. 5, it is preferable that a receiver selects a traffic light positioned at the left in the traffic lights at the intersection that a vehicle approaches, when selecting a traffic light among the traffic lights at the intersection for the vehicle.

For example, it is difficult to select a traffic light to refer to, because two traffic lights C-2 and C-3 are close to the vehicle C in the direction that the travel direction vector indicates, in the three-way intersection exemplified in FIG. 5. In this case, assume that the traffic light C-2 is the traffic light that the vehicle C will refer to. Therefore, a condition for extracting data of the traffic light C-2 is to select the traffic light at the left in the absolute position with respect to the vehicle travel direction vector. This is because it is possible to ignore the traffic light, because left-turn of vehicle is usually made under an unprotected state.

Obviously, it is possible to select the coordinates of a traffic light to practically refer to in the travel direction at a simple two-way intersection. The same concept can be applied to a five-way intersection.

FIG. 6 is a diagram illustrating the configuration of a transmitter according to an exemplary embodiment of the present invention.

Referring to FIG. 6, a transmitter using a method of controlling a vehicle approaching an intersection according to an exemplary embodiment of the present invention includes a traffic light information extracting unit 110, a transmission processing unit 120, and a transmitting unit 130.

As described above, the transmitter can be installed at each traffic light installed at an intersection. In this configuration, the transmitter wirelessly transmits signals in a straight direction and left/right turns indicated by the traffic lights to the receiver.

The traffic light information extracting unit 110 generates a cycle signal by extracting the cycle component of the traffic lights from the stop signal, go signal, and left turn signal components transmitted from the traffic lights. Further, the traffic light information extracting unit 110 also extracts the accurate coordinates of the position of the traffic lights. Accordingly, the transmission processing unit 120 processes and transmits the extracted signals through the transmitting unit 130. In this configuration, the transmitter may include a flash memory (not shown) storing accurate coordinates of the traffic lights in the positional coordinates of the traffic lights. Further, the transmitting unit can transmit the traffic light information in a message type carried by an RF signal. The configuration of the transmitter is easily understood from the well-known technologies by those skilled in the art and the detailed description is not provided.

In this configuration, it is preferable that the message includes the remaining time information until the green light and the left turn light are turned on, in the extracted cycle component and the coordinate numbers of the traffic lights, and the transmitter periodically transmits the message.

Further, the message may include the shape of the intersection. For example, the shape of intersection includes which one of two-way, three-way, four-way, and five-way intersections is the current intersection. The shape of the intersection may be used to select a traffic light after being received by the receiver.

Meanwhile, the transmitter may be installed in the traffic light control system 105 shown in FIG. 1. The transmitter is installed after signal lines of the traffic lights are separated and interfaced. The transmitter collects the signals from the traffic lights and transmits them in an RF way. For example, for a four-way intersection, the transmitter mixes and transmits the signals from the four traffic lights or transmits a specific message when transmitting a message. Obviously, the same method can be applied to other types of intersections.

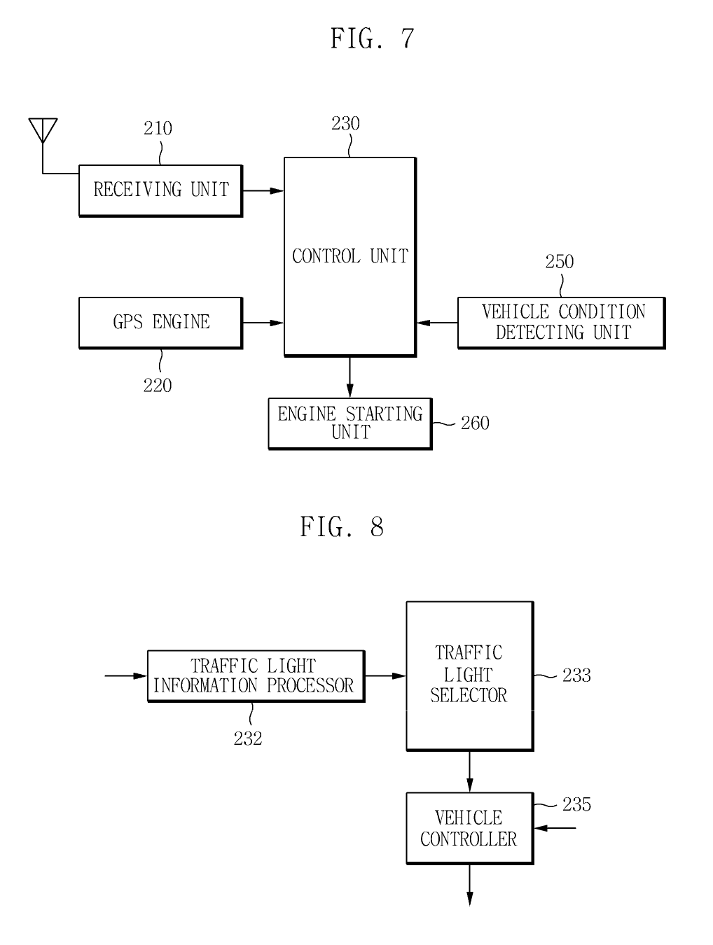

FIG. 7 is a diagram illustrating the configuration of a receiver according to an exemplary embodiment of the present invention and FIG. 8 is a diagram illustrating the internal configuration of the control unit shown in FIG. 4.

Referring to FIG. 7, a receiver using a method of controlling a vehicle approaching an intersection according to an exemplary embodiment of the present invention may include a receiving unit 210, a GPS engine 220, a control unit 230, and engine starting unit 260, and a vehicle condition detecting unit 250.

The receiving unit 210 receives traffic light information including the signal cycle and the traffic light coordinates from the transmitter and the GPS engine 220 provides positional information of the vehicle, for example, the current coordinates and the travel direction.

The vehicle condition detecting unit 250 collects information on the conditions of idling of a common vehicle. For example, the vehicle condition detecting unit 250 interfaces the components of a brake signal, a neutral gear signal, a left turn signal indicator signal or a signal described through an OBD interface that satisfy conditions for practically controlling idling of a vehicle.

The control unit 230 includes an engine starter that turns on/off an engine start motor after finally estimating the traffic light information and the positional information of a vehicle.

Referring to FIG. 8, a control unit 230 according to an exemplary embodiment of the present invention includes a traffic light information processor 232, a traffic light selector 233, and a vehicle controller 235.

The traffic light information processor 232 collects traffic light information including the positional coordinates and the signal cycle of the traffic lights installed at an intersection.

The traffic light selector 233 selects a corresponding traffic light among the traffic lights in consideration of the positional coordinates of the traffic lights and the positional information of the vehicle at the intersection. In this configuration, the traffic light selector 233 selects a traffic light on a road in the vehicle travel direction, when selecting a corresponding traffic light among the traffic lights that the vehicle at the intersection will refer to. Further, the traffic light selector 233 can select the farthest traffic light among the traffic lights on the road in the traveling direction of a vehicle, when selecting a corresponding traffic light among the traffic lights. Further, it is preferable that the traffic light selector 233 selects the traffic light at the left in the traffic lights on the road in the traveling direction of a vehicle, when selecting a corresponding traffic light among the traffic lights. See the above description for this configuration.

The vehicle controller 235 controls a vehicle on the basis of a signal cycle of a selected traffic light. Further, the vehicle controller 235 can start or stop the engine on the basis of the signal cycle of the traffic light in order to prevent idling of a vehicle. Further, it is preferable that the vehicle controller 235 collects signal lamp information of a vehicle and determines start or stop of the engine in consideration of the signal lamp information and the signal cycle of the traffic light. For example, a manual mechanism is widely used, which stops the engine when a vehicle is stopped at an intersection and the driver presses down the brake pedal with the gear at the neutral position. In this case, since the driver has no information on the time of when the green light is turned on, energy is wasted and the lifespan of specific part of the vehicle may be reduced, when the signal-waiting time is smaller than the minimum engine stop time for saving energy in accordance with the types of vehicle, including the energy for restarting the engine. Therefore, the vehicle controller 235 can more efficiently control the vehicle, using the signal cycle of the traffic light selected when controlling the idling of the vehicle.

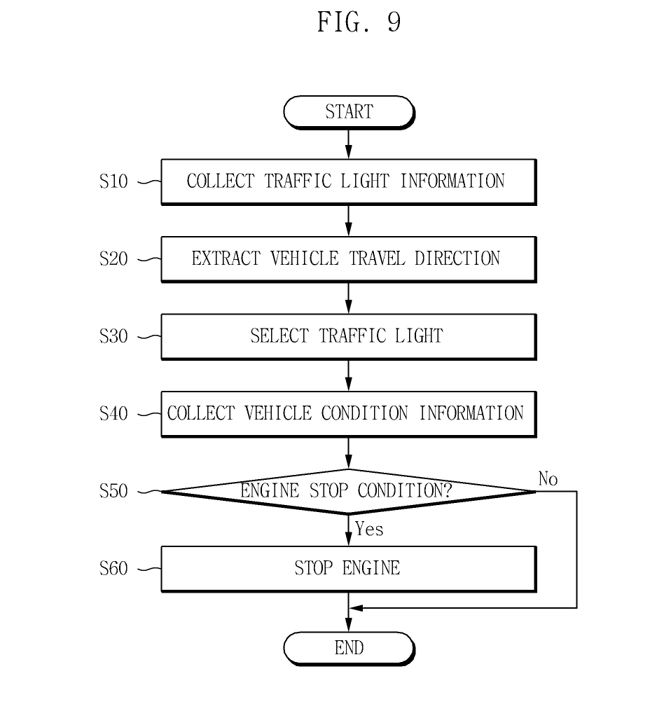

FIG. 9 is a flowchart illustrating a method of controlling a vehicle approaching an intersection according to an exemplary embodiment of the present invention.

Referring to FIG. 9, a method of controlling a vehicle approaching an intersection according to an exemplary embodiment of the present invention collects traffic light information including positional coordinates and signal cycles of traffic lights installed at the intersection (S10). For example, for a four-way intersection, it collects traffic light information of four traffic lights (traffic light coordinates, green light of the traffic lights, left-turn signal waiting time, and information on the shape of the intersection).

Thereafter, the method of controlling a vehicle approaching an intersection extracts the travel direction vector in which the vehicle stopped is traveling, for example, the directional component of the vehicle travel direction vector (S20).

Next, the method of controlling a vehicle approaching an intersection selects a corresponding traffic light among the traffic lights in consideration of the positional information of the vehicle at the intersection and the positional coordinates of the traffic lights (S30).

Next, the method of controlling a vehicle approaching an intersection selects a corresponding traffic light among the traffic lights in consideration of the positional information of the vehicle at the intersection and the positional coordinates of the traffic lights. For example, the method of controlling a vehicle approaching an intersection selects a traffic light having a vector that is the farthest in the travel direction of the vehicle.

Next, the method of controlling a vehicle approaching an intersection collects the signal cycles of the selected traffic light and vehicle condition information for determining a condition for preventing the idling of the vehicle (S40).

Thereafter, the method of controlling a vehicle approaching an intersection determines a condition for preventing the idling of the vehicle on the basis of the collected signal cycles of the traffic lights and the vehicle condition information (S50). In this process, the method of controlling a vehicle approaching an intersection stops the engine of the vehicle, when the determined result satisfies the engine stop condition (S50; Yes) (S60). For example, when the vehicle condition information satisfies the anti-idling condition, for example, it is assumed that the vehicle is in stop and the hand brake is locked. Further, the method selects a message received from the traffic light selected in S40 and assumes that 30 minutes are left for waiting for the green light in the traffic light information of the message. In this process, when the engine stop condition is set to stop the engine even if five seconds or more of signal waiting time is left under the anti-idling condition, the method stops the engine when the vehicle stops at the intersection on the basis of the signal cycle.

The method of controlling a vehicle approaching an intersection does not stop the engine, if the result determined in S50 does not satisfy the engine stop condition (S50: No). In this process, the method restarts the engine of the vehicle, when the engine is stopped (S60).

Further, according to another example of a method of controlling a vehicle approaching an intersection, it is possible to determine whether to stop the engine, on the basis of the vehicle condition information collected in S40, for example, it is determined that the vehicle will turn left or goes straight on the basis of information collected from the OBD interface or the left turn signal connected independently. For example, the method of controlling a vehicle approaching an intersection determines that the vehicle will turn left, if the vehicle condition information includes that the left turn signal is turned on in the vehicle. Further, the method of controlling a vehicle approaching an intersection controls the start/stop of the engine of the vehicle in the above method, using the remaining time until the left turn signal is turned on in the signal cycle of the selected traffic light. That is, the method determines whether to start the engine of the vehicle from the message showing how much time is remaining until the green light or the left turn light of the traffic light in the travel direction is turned on.

Obviously, the method of controlling a vehicle approaching an intersection may determine whether to start the engine in advance in contrast to the above way.

As described above the present invention has the advantage of efficiently controlling prevention of idling of a vehicle equipped with an anti-idling device or having other objects, by controlling the start of the engine of the vehicle on the basis of the signal cycle of a traffic light in the travel direction of the vehicle at the intersection.

Further, the present invention has the advantage of accurately discriminating a message of the traffic light to refer to, using the positional information of the traffic light and the travel information coordinates of the vehicle at the intersection.

Further, the present invention can be used for controlling a vehicle by selecting a traffic light that the vehicle will refer to, at various types of intersections.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Accordingly, the actual technical protection scope of the present invention must be determined by the spirit of the appended claims.

What is claimed is:

1. A method of controlling a vehicle approaching an intersection, the method comprising:
collecting traffic light information including signal cycles and positional coordinates of traffic lights installed at the intersection;
selecting a corresponding traffic light among the traffic lights in consideration of positional information of the vehicle at the intersection and the positional coordinates of the traffic lights; and
controlling the vehicle on the basis of the signal cycle of the corresponding traffic light.

2. The method of claim 1, wherein the selecting the corresponding traffic light determines a travel direction on the basis of the positional information of the vehicle at the intersection and selects the corresponding traffic light among the traffic lights by matching the positional coordinates of the traffic lights with the travel direction of the vehicle in a coordinate plane.

3. The method of claim 2, wherein the corresponding traffic light is selected among traffic lights at the intersection in the travel direction.

4. The method of claim 2, wherein the corresponding traffic light is a traffic light farthest away from the vehicle among traffic lights at the intersection in the travel direction.

5. The method of claim 2, wherein the corresponding traffic light is a traffic light at left among traffic lights at the intersection in the travel direction.

6. The method of claim 1, wherein the controlling the vehicle starts or stops an engine of the vehicle on the basis of the signal cycle of the corresponding traffic light in order to prevent idling of the vehicle.

7. The method of claim 6, further comprising collecting signal lamp information of the vehicle,
wherein the controlling the vehicle starts or stops the engine of the vehicle in consideration of the signal lamp information and the signal cycle of the corresponding traffic light.

8. A device for controlling a vehicle approaching an intersection, the device comprising:
a traffic light information process unit that collects traffic light information including signal cycles and positional coordinates of traffic lights installed at the intersection;
a traffic light selecting unit that selects a corresponding traffic light among the traffic lights in consideration of positional information of the vehicle at the intersection and the positional coordinates of the traffic lights; and
a vehicle control unit that controls the vehicle on the basis of the signal cycle of the corresponding traffic light.

9. The device of claim 8, wherein the traffic light selecting unit determines a travel direction on the basis of the positional information of the vehicle at the intersection, and selects the corresponding traffic light among the traffic lights by matching the positional coordinates of the traffic lights with the travel direction of the vehicle in a coordinate plane.

10. The device of claim 9, wherein the traffic light selecting unit selects the corresponding traffic light among traffic lights at the intersection in the travel direction.

11. The device of claim 9, wherein the traffic light selecting unit selects a traffic light farthest away from the vehicle among traffic lights at the intersection in the travel direction as the corresponding traffic light.

12. The device of claim 9, wherein the traffic light selecting unit selects a traffic light at left among traffic lights at the intersection in the travel direction as the corresponding traffic light.

13. The device of claim 8, wherein the vehicle control unit starts or stops an engine of the vehicle on the basis of the signal cycle of the corresponding traffic light in order to prevent idling of the vehicle.

14. The device of claim 13, wherein the vehicle control unit collects the vehicle signal lamp information and starts or stops the engine of the vehicle in consideration of the signal cycle of the corresponding traffic light and the signal lamp information of the vehicle.
